(19) United States
(12) Patent Application Publication
(10) Pub. No.: US 2005/0121936 A1
(43) Pub. Date: Jun. 9, 2005

(54) Method and apparatus for installing windshields

(76) Inventor: Dean Kennett, Yukon, OK (US)

Correspondence Address: DUNLAP, CODDING & ROGERS P.C., PO BOX 16370, OKLAHOMA CITY, OK, 73113, US

(21) Appl. No.: 10/751,721

(22) Filed: Jan. 5, 2004

Related U.S. Application Data
(60) Provisional application No. 60/528,149, filed on Dec. 9, 2003.

(51) Int. Cl. B60J 1/02

(52) U.S. Cl. 296/96.21

(57) ABSTRACT

Windshield support assemblies which support a windshield during replacement of a windshield of a vehicle are disclosed, as well as a method for using such windshield support assemblies. Each of the windshield support assemblies has a support member and a self-tapping screw which permits the windshield support assembly to be connected to a frame of the vehicle at a position adjacent a lower end of a windshield to be replaced. Thus, the windshield support assemblies are positioned to support a new windshield during installation of the new windshield.

### CROSS REFERENCE TO RELATED APPLICATIONS

This application claims the benefit under 35 U.S.C. 119(e) of U.S. Provisional application No. 60/528,149, filed Dec. 9, 2003.

### BACKGROUND OF THE INVENTION

The present invention relates generally to a method and apparatus for supporting a windshield during installation of the windshield. In one aspect, the present invention relates to windshield support assemblies for supporting a windshield during installation, and to a method for using such windshield support assemblies when installing a windshield.

### DESCRIPTION OF PRIOR DEVELOPMENTS

Vehicle windshields often become cracked or damaged and when such occurs it is necessary to replace the windshield. The windshield is typically bonded to a window frame of a vehicle with a urethane bonding agent. Because the urethane bonding agent often requires several hours to set up and cure, various types of supports have heretofore been proposed for assisting in the setting of windshields, such as the windshield spacer disclosed in U.S. Pat. No. 6,170,208 B1.

In addition, problems have been encountered in positioning the windshield in the window frame of a vehicle due to the weight and bulkiness of the windshield. Thus, the windshield is subject to being broken during handling and installation.

Accordingly, a need exists for an improved method and apparatus for installing windshields which substantially eliminates breakage of the windshield during installation and which properly positions the windshield relative to the window frame of the vehicle. It is to such a method and apparatus that the present invention is directed.

### BRIEF DESCRIPTION OF THE DRAWINGS

FIG. 1 is a fragmental, pictorial representation of a vehicle having a windshield thereof removed and showing two windshield support assemblies of the present invention connected to a portion of a frame of the vehicle.

FIG. 2 is a fragmental, pictorial representation of a portion of a vehicle illustrating a person installing a windshield wherein the windshield is supported on two of the windshield support assemblies of the present invention.

FIG. 3 is a perspective view of one of the windshield support assemblies constructed in accordance with the present invention.

FIG. 4 is a side elevational view, partially in cross section, of the windshield support assembly of FIG. 3.

### DETAILED DESCRIPTION OF THE DRAWINGS

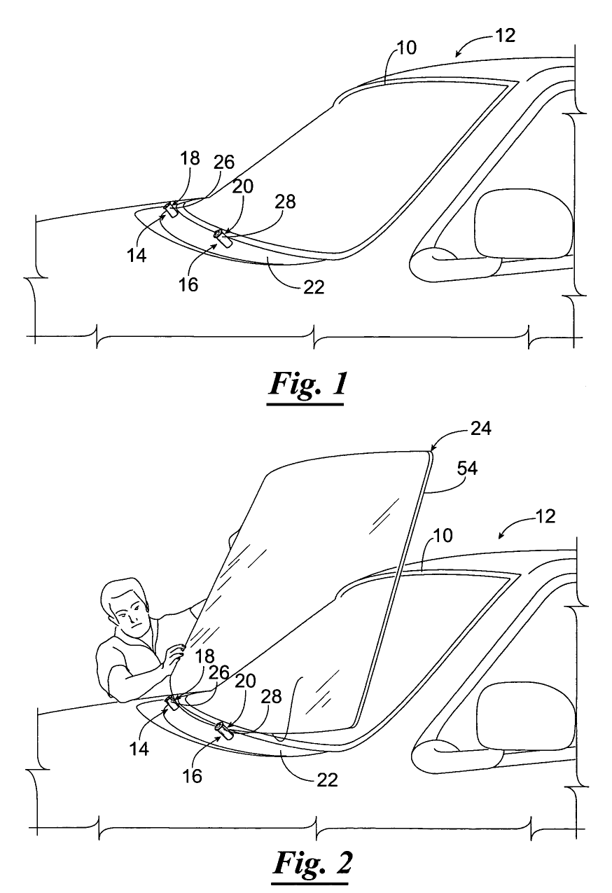

Referring now to FIGS. 1 and 2, shown therein is a window frame 10 of a vehicle 12 having two windshield support assemblies 14 and 16 connected to the vehicle 12. The windshield support assemblies 14 and 16 are provided with support members 18 and 20, respectively, which are connected to a portion of a frame 22 located in the pinch weld of the vehicle 10 prior to removal of the damaged windshield so that the support members 18 and 22 of the windshield support assemblies 14 and 18 are properly positioned relative to the window frame 10 for supporting a windshield 24 during installation of the windshield 24.

The windshield support assemblies 14 and 16 are connected to the portion of the frame 22 such that upper surfaces 26 and 28 of the support members 18 and 20, respectively, are disposed substantially adjacent a lower edge (not shown) of a damaged windshield. By positioning the windshield support assemblies 14 and 16 such that their respective support members 18 and 20 are disposed substantially adjacent a lower edge of the damaged windshield, the support members 18 and 20 are in a proper position for supporting the replacement windshield 24, both horizontally and vertically, during placement of the replacement windshield 24 in the window frame 10 of the vehicle 12. By positioning the windshield support assemblies 14 and 16 substantially adjacent a portion of the window frame 10, the support members 18 and 20 of the windshield support assemblies 14 and 16 prevent the replacement windshield 24 from sliding or moving in a downward direction as the replacement windshield 24 is bonded to the window frame 10 of the vehicle 12, while at the same time preventing the weight of the replacement windshield 24 from extruding urethane or other sealants or bonding agents from between the replacement windshield 24 and the window frame 10. Thus, the windshield support assemblies 14 and 16 not only assist one in positioning the replacement windshield 24 in a proper position within the window frame 10, but also stabilizes the replacement windshield 24 in a desired position during curing of the urethane or sealant or bonding agent so that a substantially water-tight seal is formed between the replacement windshield 24 and the window frame 10 of the vehicle 12.

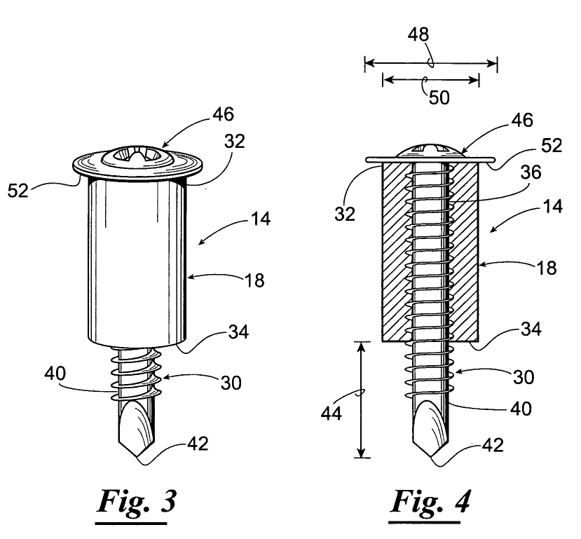

The windshield support assemblies 14 and 16 are substantially identical in construction and function. Thus, only the windshield support assembly 14 will be described in detail herein after with reference to FIGS. 3 and 4.

The windshield support assembly 14 includes the support member 18 and a self-tapping or sheet metal screw 30. The self-tapping screw 30 is driven into a portion of the frame 22 of the vehicle 12 located in the pinch weld of the vehicle 12 (FIGS. 1 and 2) such that the support member 18 of the windshield support assembly 14 is disposed adjacent and below the old windshield (not shown). Thus, the windshield support assembly 14 is positioned relative to the window frame 10 so as to support the replacement windshield 24 during installation of the replacement windshield 24.

The support member 18 of the windshield support assembly 14 is provided with a first or upper end 32, a second or lower end 34 and a passageway 36 extending there between. The support member 18 of the windshield support assembly 14 is fabricated of a substantially non-resilient material so as to provide stability to the replacement windshield 24 when the replacement windshield 24 is positioned thereon and disposed within the window frame 10 of the vehicle 12.

Any suitable material can be employed to fabricate the support member 18 of the windshield support assembly 14 provided that the material from which such support member 18 is fabricated of any material which is substantially non-resilient. Examples of materials from which the support member 18 can be fabricated includes “nylon 6/6”, “Teflon” or polyolefins such as high density polypropylene and high density polyethylene, wood, metal and the like.

The cross sectional configuration of the support member 18 can be cylindrical, square shaped, rectangular, hexagonal shape or any other shape as long as the support member 18 is capable of supporting the replacement windshield 24 thereon during positioning of the replacement windshield 24 in the window frame 10 of the vehicle 12, and supporting the replacement windshield during curing of the urethane or other bonding material employed to secure the replacement windshield 24 within the window frame 10. However, desirable results have been obtained wherein the support member 18 is a cylindrical-shaped member having a circular cross-section.

The overall dimensions of the support member 18 can vary widely as long as the support member 18 is capable of supporting the replacement windshield 24 thereon. When the support member 18 is a cylindrical shaped member, desirable results have been obtained wherein the support member 18 is provided with a circular cross section having a diameter of about 3/8 inch, a length of about 3/4 inch and wherein the passageway 36 extending between the first end 32 and the second end 34 thereof is provided with a diameter of about ⅛ inch.

The self-tapping screw 30 employed to secure the support member 18 to the frame 22 of the vehicle 12 will vary in length and size depending upon the length of the support member 18, as well as the diameter of the passageway 36 extending between the first end 32 and the second end 34 of the support member 18. Desirably the self-tapping screw 30 is capable of cutting it's own hole in the frame 22, have a cylindrical shaft 40 which can be threadably disposed through the passageway 36 extending between the first and second ends 32, 34 of the support member 18, and has a length such that a distal end 42 of the self-tapping screw 30 is spaced a distance 44 from the second end 34 of the support member 18. Preferably, the self-tapping screw 30 is provided with a head portion 46 which has a diameter 48 greater than a diameter 50 of the support member 18 so that a support ledge 52 is formed between the head portion 46 of the self-tapping screw 30 and the first end 32 of the support member 18 when the self-tapping screw 30 is threadably disposed through the passageway 36 of the support member 18. For example, when the support member 18 is a cylindrical shaped member having a length of about 3/4 inch, a diameter of about 3/8 inch and the passageway extending therethrough is substantially centrally disposed and has a diameter of about 1/8 inch, the self-tapping screw 38 employed to connect the support member 18 to the frame 22 of the vehicle 12 desirably has a length of about 1/4 inch, and the head portion 46 of the self-tapping screw 30 has a diameter of about 7/16 inch.

While the self-tapping screw 30 has been shown and described as the connector for connecting the support member 18 of the windshield support assembly 14 to the frame 22 of the vehicle 12, it should be understood that any type of connector capable of connecting the support member 18 to the vehicle can be employed as long as the connector permits the support member 18 to be mechanically connected to the frame 22 of the vehicle 12 and subsequently removed therefrom after installation of the replacement windshield 24 has been completed and the urethane or bonding agent has set and cured to provide a fluid-tight seal around the replacement windshield 24.

Referring again to FIGS. 1 and 2, the method of installing the replacement windshield 24 in the window frame 10 of the vehicle 12 will now be described. Initially, wiper blades (not shown) of the vehicle 12 are removed and thereafter cowling (also not shown) which is disposed substantially adjacent a lower edge of a damaged windshield is removed. The windshield support assemblies 14 and 16 are then secured in position below the damaged windshield by screwing the self-tapping screws, such as a self-tapping screw 38, into the frame 22 of the vehicle 12 such that the windshield support assemblies 14 and 16 are disposed in the pinch weld of the frame 22 and the support member 18 and 20 of the windshield support assemblies 14 and 16 are positionable adjacent a lower edge (not shown) of the damaged windshield. Thereafter, the damaged windshield is removed and the window frame 10 cleaned of any remaining debris from the previous sealant used to secure the damaged windshield in the window frame 10 of the vehicle 12. Once the residual sealant has been cleaned from the window frame 10 of the vehicle, an effective amount of sealant, such as a bead of urethane, is applied to one of a perimeter portion of a lower side 54 of the replacement windshield 24 or the window frame 10. Alternately, the sealant can be applied to both the perimeter of the lower side 54 of the windshield 24 and the window frame 10 of the vehicle 12.

Once the effective amount of urethane has been applied, the replacement windshield 24 is then positioned on at least one support assembly, and preferably both of the windshield support assemblies 14 and 16. Thereafter, the replacement windshield 24 is moved into engagement with the window frame 10 while the replacement windshield 24 remains supported on the support assemblies 14 and 16. The replacement windshield 24 is maintained in a supported position on the support members 18 and 20 of the windshield support assemblies 14 and 16 for a period of time effective to permit the urethane to cure and thereby provide a fluid-tight seal between the replacement windshield 24 and the window frame 10.

After the windshield 24 has been properly set within the window frame 10, and the urethane has cured, the windshield support assemblies 14 and 16 are removed from the portion of the frame 22 of the vehicle 12 located in the pinch weld of the vehicle 12 by backing off the self-tapping screws, such as a self-tapping screw 38. Once the windshield support assemblies 14 and 16 have been removed, the cowling is replaced, and thereafter the wiper blades are installed.

While it has been shown as utilizing the windshield support assemblies 14 and 16 for installing the replacement windshield 24, it should be understood that one could employ only one of the windshield support assemblies, such as the windshield support assembly 14, if desired, without departing from the concept of the present invention. Further, when employing both of the windshield support assemblies 14 and 16 for installing the replacement windshield 24, it is desirable that the windshield support assemblies 14 and 16 by spatially disposed so as to enhance stabilization of the replacement windshield 24 thereon.

It should be noted that the windshield support assemblies 14 and 16 of the present invention permit an individual to properly position the replacement windshield 24 within the window frame 10 of the vehicle 12 while substantially reducing the likely-hood of breaking the replacement windshield 24. In addition, the ledge 52 formed between the head portion of the self-tapping screws, such as the head portion 46 of the self-tapping screw 30, and the first ends of the support members, such as the first end 32 or the support member 18, cooperate to prevent the replacement windshield 24 from inadvertently slipping off of the support members 18 and 20 of the windshield support assemblies 14 and 16 when the windshield support assemblies 14 and 16 are properly attached to the frame 22 of the vehicle 12 and the replacement windshield 24 is positioned thereon.

While the head portions of the self-tapping screws, such as the head portion 46 of the self-tapping screw 30, have been shown as having a diameter greater than the diameter of the support members 18 and 20 of the windshield support assemblies 14 and 16, it should understood that the diameter of the head portions of the self-tapping screws of the windshield support assemblies 14 and 16 can be less than the diameter of the support members 18 and 20 of the windshield support assemblies 14 and 16.

It should understood that while the present invention has been described in connection with a preferred embodiment, those skilled in the art would appreciate that other modifications can be made without departing from the spirit of the invention after studying the specification and the drawings.

1. An apparatus for assisting in the replacement of a windshield, the apparatus comprising:
at least one window support assembly comprising;
a support member having a first end, a second end and a passageway extending there between; and
a connector disposable within the passageway of the support member, a distal end portion of the connector extending outwardly from the second end of the support member for selectively connecting the at least one support assembly to a portion of a frame of the vehicle located in a pinch weld of the vehicle such that the support member is engagable with a lower edge of a windshield for supporting the windshield during positioning of the windshield in a window frame of the vehicle and for stabilizing the windshield within the window frame of the vehicle while the windshield is bondingly connected thereto.

2. The apparatus of claim 1 wherein the support member is provided with a circular cross section.

3. The apparatus of claim 2 wherein the connector is further characterized as having a head portion on a proximal end of the connector, the head portion having a diameter greater than the diameter of the support member such that, in an assembled position, a peripheral portion of the head portion of the connector cooperates with first end of the support member to provide a ledge for stabilizing the replacement windshield on the support member.

4. The apparatus of claim 3 wherein the support member is fabricated of a substantially non-resilient, corrosion resistant material, and wherein the connector is a self-tapping screw, the self-tapping screw threadably disposed through the passageway of the support member such that the self-tapping screw is connected to the support member.

5. The apparatus of claim 3 wherein the support member is provided with a substantially circular cross-sectional configuration having a length of about 3/4 inch, a diameter of about 3/8 inch and wherein the passageway extending there through is substantially centrally disposed and has a diameter of about 1/8 inch.

6. The apparatus of claim 5 wherein the self-tapping screw has a length of about 1 and ¼ inches.

7. The apparatus of claim 6 wherein the head portion of the self-tapping screw has a diameter of about 7/16 inch.

8. A method for installing a replacement windshield comprising the steps of:
removing wiper blades of the vehicle;
removing cowling disposed substantially adjacent a lower edge of a damaged windshield;
providing at least one support assembly comprising a support member and a connector, the support member having a first end, a second end and a passageway extending there between, the connector disposable within the passageway of the support member such that a distal end portion of the connector extends outwardly from the second end of the support member;
connecting the at least one windshield support assembly to a portion of a frame of the vehicle located in a pinch weld of the vehicle via the distal end portion of the connector such that the support member is aligned with a lower edge of the damaged windshield;
removing the damaged windshield;
cleaning the window frame of the vehicle to remove residual sealant;
applying an effective amount of a sealant to a perimeter portion of at least one of a lower side of a replacement windshield and the window frame;
positioning the replacement windshield on the at least one support assembly;
moving the replacement windshield into engagement with the window frame while the windshield remains supported on the at least one support assembly and maintaining the replacement windshield on the at least one support assembly for a period of time effective to permit the sealant to cure and thereby provide a fluid-tight seal between the replacement window and the window frame;
disconnecting and removing the at least one windshield support assembly from the portion of a frame of the vehicle located in the pinch weld of the vehicle;
replacing the cowling; and
reconnecting the wiper blades.

9. The method of claim 8 wherein at least two spatially disposed windshield support assemblies are connected to the portion of the frame of the vehicle located in the pinch weld of the vehicle.

10. The method of claim 9 wherein each of the support members of the at least two windshield support assemblies is provided with a circular cross section.

11. The method of claim 10 wherein each of the connectors of the at least two windshield support assemblies is further characterized as having a head portion on a proximal end thereof, the head portion having a diameter greater than the diameter of the support member such that, in an assembled position, a peripheral portion of the head portion of the connector cooperates with an outer surface of the support member to create a support ledge for assisting in stabilizing the replacement windshield on the support members.

12. The method of claim 11 wherein each of the support members of the at least two windshield support assemblies is fabricated of a substantially non-resilient, corrosion resistant material, and wherein the connector of each of the at least two windshield support assemblies is a self-tapping screw, one self-tapping screw threadably disposed through each of the passageways of the support members such that the self-tapping screws are connected to the support members.

13. The method of claim 12 wherein each support member of the at least two windshield support assemblies is provided with a substantially cylindrical configuration having a length of about 3/4 inch, a diameter of about 3/8 inch and wherein the passageway extending there through is substantially centrally disposed and has a diameter of about 1/8 inch.

14. The method of claim 13 wherein the self-tapping screw of each of the at least two windshield support assemblies has a length of about 1 and 1/4 inches.

15. The method of claim 14 wherein the head of the self-tapping screw of each of the at least two windshield support assemblies has a diameter of about 7/16 inch.
